(19) United States
(12) Patent Application Publication
(10) Pub. No.: US 2002/0106439 A1
(43) Pub. Date: Aug. 8, 2002

(54) New flavored improver for baking applications

(76) Inventor: Stefan Cappelle, Langemark-Poelkapelle (BE)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 10/007,006

(22) Filed: Nov. 9, 2001

(30) Foreign Application Priority Data
Nov. 17, 2000 (EP) 00 870 274.8

(51) Int. Cl. A23D 7/00

(52) U.S. Cl. 426/602; 426/654

(57) ABSTRACT

The present invention comprises a flavored bread improver for the preparation of bakery products and bakery products comprising the improver. The present invention also comprises the preparation process of the flavored bread improver.

### CROSS-REFERENCE TO RELATED APPLICATIONS

This application claims priority to European Application Serial Number 00 870 274.8, filed Nov. 17, 2000, the disclosure of which is herein incorporated by reference in its entirety.

### BACKGROUND OF THE INVENTION

1. Field of the Invention

The present invention is related to a flavored bread improver for the preparation of bakery products and to bakery products comprising the improver.

The present invention is also related to the preparation process of the flavored bread improver.

2. Description of the Related Art

Baked bread products are made of the basic ingredients: flour (mostly wheat or rye flour), water, salt and yeast. Other types of flour (barley, oats, soy, sunflower, cassava and other). The process of baking is subject to a lot of variations due to external (temperature, humidity, handling) and internal (variations of flour and yeast quality) factors.

To obtain a more reliable production process and a constant end product the baker uses ingredients and additives. These products are mostly added as one coformulated product and are known as improvers. These improvers may contain emulsifiers and fats, enzymes, sugars, organic acids, minerals, polysaccharides and proteins. This includes products such as diacetyltartaric acid esters of monoglycerides, lactic acid ester of monoglycerides, monoglycerides, amylases, hemicellulases and pentosanases, oxidases, lipases, proteinases, glucose, fructose, sucrose, ascorbic acid, lactic acid, phosphates, sulfates, guar, locust bean gum, gluten, soy proteins.

The list is not exhaustive and is presented as an illustration of a possible improver. A mixture of ingredients active in the preparation process of baked goods is called an improver as soon as it contains more than one class of active components mixed together as to optimize by a synergetic effect their performances in the baking process.

The improver can be formulated as a liquid, as a paste or more commonly as a powder. The powdered formulation contains the active ingredients as above-mentioned and usually a carrier substance. The carrier substance is added to the active ingredients in order to dilute them to the suitable concentration. The improver will be added by the baker in a concentration of 0.5 to 20% to the flour.

The most currently used carrier substances are starch, wheat flour or soy flour. The powdered formulation of the improver is very stable, and easy to weigh and to store.

An example of a known improver composition for baking applications is a blend of mono-, di- and triglycerides encapsulated in a mixture of proteins and carbohydrates. In this composition, a co-emulsifier like lecithin or tween is needed to stabilize the emulsion and to ensure optimal activity of the monoglycerides in the final baking application.

Until now, a flavoring composition had to be added on top of above described composition comprising necessarily the co-emulsifier.

U.S. Pat. No. 4,424,135 describes an emulsifier system for the tertiary recovering of oil.

### SUMMARY OF THE INVENTION

The present invention comprises a new flavored bread improver composition that contains less active ingredients than the compositions of the state of the art while maintaining technical properties and organoleptic properties in a bakery product.

### DETAILED DESCRIPTION OF THE PREFERRED EMBODIMENT

The present invention is related to a flavored bread improver comprising an emulsifier, an encapsulated matrix and a co-emulsifier consisting of a blend of aroma chemicals having co-emulsifier properties.

Preferably, the emulsifier is a blend of mono-, di- and triglycerides.

The blend of aroma chemicals used in the present invention is a blend of typical alcohol produced during yeast fermentation like iso-amylalcohol, iso-butanol, phenylalcohol (preferably in the proportion 1:5:1) or other alcohols containing more than 3 carbon atoms (and preferably less than 10 carbon atoms), possibly combined with minor aromatic components.

In the composition according to the invention, the encapsulated matrix is advantageously a mixture of proteins and carbohydrates suitable to encapsulate the emulsifier and the blend of aromas working as a co-emulsifier.

In the composition according to the invention, it is not necessary to add an usual co-emulsifier, like lecithin or an element selected from the group consisting of polyoxyethylene sorbitan monooleate and polyoxoethylene sorbitan monostearate.

The stabilization of the emulsion is unexpectedly obtained by the blend of aroma chemicals that are unexpectedly adequate for obtaining a stabilization of the emulsion and to insure advantageously the optimal activity of the monoglycerides in baking applications.

Furthermore, the composition according to the invention can be used as a powdered and flavored improver with controlled release properties due to the encapsulation and the high melting point of the monoglycerides.

Another aspect of the present invention is related to a powder formulation of the improver according to the invention (possibly combined with carriers or other active ingredients) by spray-drying of a stable emulsion comprising the improver composition according to the invention, and to a baked product comprising the powder formulation or the improver composition with other known usual food ingredients.

It has also been observed that the baked products show improved flavor retention, because the blend of aroma chemicals is stabilized within the encapsulated solidified monoglycerides in the improver composition according to the invention.

Preferably, the improved flavoring composition according to the invention is obtained by the following method:

emulsifiers, being preferably monoglycerides or a blend as above-described, are heated until they are melted,

the proteins and carbohydrates are mixed in an aqueous phase to form an aqueous solution,

a blend of aroma chemicals is added to the emulsifiers just before the addition of the aqueous solution of proteins and carbohydrates,

a final emulsion is obtained by passing the blend through an homogenizer, a stable emulsion being thus formed,

this emulsion is then possibly spray-dried, resulting in a stable encapsulated flavored composition.

The spray-dried composition can then be added to usual ingredients of baked products and its activity in the baking tests is comparable to the one of the compositions with normal co-emulsifiers. However, the retention of the flavor in the baked product is improved compared to an on top addition of a flavor as proposed in the state of the art.

Another aspect of the present invention is the use of the blend of aroma chemicals as an emulsifier, preferably in a bread improver composition.

The present invention will be described in details in the following non-limiting examples.

### EXAMPLES

### Example 1

A normal emulsifying system (or composition) with lecithin as co-emulsifier is compared with the new composition according to the invention comprising a blend of aroma chemicals as co-emulsifier.

The composition of the blend of chemicals (ACI) is iso-butanol, iso-amylalcohol and phenylalcohol in the proportion 1:5:1.

This flavor simulates a typical yeast sponge flavor.

Composition:

| | Normal form | Flavored form |
|---|---|---|
| Monoglycerides | 20 | 20 |
| Lecithin | 10 | |
| Flavour AC1 | | 10 |
| Water | 50 | 50 |
| Ca-caseinates | 2.5 | 2.5 |
| Maltodextrines | 17.5 | 17.5 |

The monoglycerides were heated to 80° C. (liquid). The water with the proteins and the maltodextrines were also heated to 80° C.

This mixture was then passed through a homogenizer at 150 bar inlet pressure. In both cases a stable and very fine emulsion was obtained.

This emulsion was dried in a spray drier with inlet temperature of 170° C. and outlet of 90° C. In both cases a fine powder was obtained.

The following baking tests were performed.

### Results

Very comparable activity is found in both compositions. Due to better retention and stability of the flavor, only 70% of the flavor was needed compared to the on top addition of the flavor on the normal emulsifier system.

### Baking Trials

Different dosages are tested: only a minor difference is obtained in the baking trials at 100 g/100 kg flour.

| White | Normal | Flavored |
|---|---|---|
| 2450 | 2725 | 2650 |
| | +11% | +8% |

### Flavor Retention

0.035% of flavor on top of normal formulation 50 g (0.01%), 100 g (0.02), 150 g (0.03), 200 g (0.04).

The flavors were equal somewhere between 100 and 150 g of flavored improver. This is in fact about 0.025% of flavor in the formulation. This means that only 70% of the usual concentration of flavor should be added.

What is claimed is:

1. A composition for a flavored bread improver comprising:
an emulsifier;
an encapsulated matrix; and
a co-emulsifier,
wherein said co-emulsifier comprises a blend of aroma chemicals having co-emulsifier properties.

2. The composition of claim 1, wherein said emulsifier comprises a blend of monoglycerides, diglycerides, and triglycerides.

3. The composition of claim 1, wherein said encapsulated matrix comprises a mixture of proteins and carbohydrates.

4. The composition of claim 1, wherein said blend of aroma chemicals comprises at least two chemicals, wherein said chemicals are selected from the group consisting of alcohols with more than three carbon atoms.

5. The composition of claim 4, wherein said blend of aroma chemicals comprises iso-amlyalcohol, iso-butanol, and phenylalcohol.

6. The composition of claim 1, wherein the composition is an emulsion.

7. The composition of claim 1, wherein said composition is a spray-dried composition.

8. The composition of claim 4, further comprising minor aromatic components, wherein said components are combined with said chemicals.

9. A method of making a composition for a flavored bread improver, comprising:
heating an emulsifier until said emulsifier is melted;
mixing proteins and carbohydrates in an aqueous phase to form an aqueous solution;
adding a blend of aroma chemicals to said emulsifier before their addition to said aqueous solution; and
obtaining a final stable emulsion following a passing of said blend through an homogenizer.

10. The method of claim 9, further comprising spray-drying the emulsion.

11. The method of claim 9, further comprising forming a stable encapsulated flavored composition.

12. A flavored bread improver produced in accordance with the method of claim 9.

13. The method of claim 9, wherein said emulsifier comprises a blend of monoglycerides, diglycerides, and triglycerides.

14. The method of claim 9, wherein said bread improver comprises an encapsulated matrix comprising a mixture of proteins and carbohydrates.

15. The method of claim 9, wherein said blend of aroma chemicals comprises at least two chemicals, wherein said chemicals are selected from the group consisting of alcohols with more than three carbon atoms.

16. The method of claim 15, wherein said blend of aroma chemicals comprises iso-amlyalcohol, iso-butanol, and phenylalcohol.
